(19) United States
(12) Patent Application Publication
(10) Pub. No.: US 2006/0258778 A1
(43) Pub. Date: Nov. 16, 2006

(54) Dynamic surface-structure fire suppression

(76) Inventors: Thomas S. Ohnstad, Salem, OR (US); Russell A. Monk, Salem, OR (US); Michael R. Dennis, Scappoose, OR (US)

Correspondence Address: ROBERT D. VARITZ, P.C., 4915 SE 33RD PLACE, PORTLAND, OR, 97202, US

(21) Appl. No.: 11/411,688

(22) Filed: Apr. 25, 2006

Related U.S. Application Data
(60) Provisional application No. 60/676,179, filed on Apr. 28, 2005.
(60) Provisional application No. 60/724,237, filed on Oct. 5, 2005.

(51) Int. Cl. C09K 21/14

(52) U.S. Cl. 523/179; 524/450

(57) ABSTRACT

A self-protecting, fire-inhibiting structure including wall structure formed of an elastomeric material having an outwardly exposed surface which is at risk for exposure to the heat of fire, and within that wall structure, a distributed population of intumescence elements. Associated with such structure is a fire-inhibition method for protecting a target structure having a dynamic-motion surface, including the steps of (a) applying an elastomeric, fire-resistant coating having a heat-responsive growth nature to such a surface with the applied coating having an outer side, and (b), on the occurrence of the outer side of that coating becoming exposed to the heat of fire, invoking the heat-responsive growth nature of the coating progressively to grow the coating's thickness as temperature rise within the coating progresses inwardly from the coating's outer side.

### CROSS REFERENCES TO RELATED APPLICATIONS

This application claims priority to two currently co-pending U.S. Provisional Patent Applications, and hereby incorporates by reference herein all of the disclosure contents of these two cases. These applications include U.S. Provisional Patent Application Ser. No. 60/676,179, filed Apr. 28, 2005, for “Dynamic-Surface, Elastic-Coating Fire Inhibition”, and U.S. Provisional Patent Application Ser. No. 60/724,237, filed Oct. 5, 2005, for “Tire Enhancement with Integral Fire Suppression”.

### BACKGROUND AND SUMMARY OF THE INVENTION

This invention relates to protecting a dynamic-motion structure—called herein a “target” structure—against a fire threat via a special surfacing structure which is (1) made to be inherently fire resistant, and (2) constructed to grow in fire-insulating thickness in rapid response to the heat of fire. According to the invention, this surfacing structure is either formed integrally with and as a part of target structure which is to be protected (one form of the invention), or is applied as an outer coating to an independent target structure, also referred to herein as another structure (another form of the invention). This surfacing structure includes imbedded intumescence elements that react to a proximate fire with a size-growing and out-bursting popping response.

Born out of defensive reaction to one of the many grim and current realities of modern military combat, and also recognizing the need to address various non-military, potential fire-disaster events, this invention takes square aim at nullifying, or at least greatly suppressing, the threat to a structure, and therethrough to proximate personnel, of an aggressive fire.

For the sake of exposition herein, the invention is described in the context of what is called a “target” structure. Specific illustrations of such a target structure, drawn especially from the military context, include (a) the sidewalls of vehicle tires, (b) the shells of military helmets, and (c) the undersurfaces of various military vehicles, such as personnel-carrying vehicles. Other, and non-military, target-structure candidates will readily come to the minds of those skilled in the art. The target structure may either take the form of something to which a protective coating made in accordance with the invention is applied, or it may be an integrated structure which includes the structure of the invention.

The invention, as one will readily see and learn from the description which follows herein, is significantly endowed with anti-fire-reaction mechanisms, all of which collaborate in rapid response to a fire threat to deny time's advantage to a proximate fire.

A good illustration of a situation addressed by the invention involves the serious risk to life and vehicles which occurs in a military theater where an attack near the tires of a military vehicle creates so hot and so rapidly-generated a fire that, essentially, unstoppable, intense-heat, tire combustion begins, or can begin, within seconds. Tires are known to furnish a rich source of fire fuel once combustion begins, and their aggressive burning is extremely dangerous and hard to stop in any reasonably short period of time. The threat to personnel and equipment in such a situation is nearly instant, severe, and devastating.

The present invention, as stated above, takes aim at thwarting this kind of event via utilizing, in one form of the invention, a special, growth-capable, effectively intumescent surface coating which is suitably applied to the outside of an at-risk structure. This coating features, preferably, a high-stretch (up to about 300-400%) elastomeric body of inherently fire-resistant material in which there is embedded a population of intumescent sodium silicate crystals, preferably resident in this coating in a population which occupies about 30-50% by volume of the body of the thus combined overall material.

When this coating becomes exposed to high heat, the crystals rapidly react to such heat by expanding in an explosive, popcorn-like manner, thus to swell the thickness of the coating quickly to grow a progressively thickening, heat-insulating barrier in relation to a protected target structure. The elastomeric coating body enhances the resulting thickness growth of the protective coating by holding together, at least initially, the expanding crystals. It especially adds to the protective nature of this invention by enabling the progressive “growing” of coating thickness as outside fire heat continues progressively to raise, to “popping” temperature, sodium silicate crystals initially “un-triggered” because of being deeply embedded in the entraining elastomeric coating material.

The first crystals to “pop”, and to begin effective coating-layer thickness growth, are those which are disposed near the outside of the coating. As the coating thickness increases, and as deeper crystals eventually “rise” to popping temperature, there occurs a significant, progressive enlargement of the depth of the coating, thus to respond dynamically to inhibit protected-structure combustion. In this respect, it will be apparent that as coating thickness increases, the time to temperature-rise for popping to occur with respect to more deeply embedded crystals becomes progressively enlarged as the popping temperature “front” shifts inwardly and more distantly from the outside fire heat.

Elasticity in the coating of this invention, with respect to that embodiment of the invention wherein surface coating is the approach employed to implement the invention, enables the coating to remain viable and poised for responsive anti-fire reaction even though the structure which it protects, such as the sidewall surface of a tire, may have experienced a long life history of dynamic flexing motion.

In a second approach, or embodiment, relative to implementing the invention, what is proposed is the direct incorporation of intumescence elements, such as the mentioned sodium silicate crystals, in a target, to-be-protected structure, such as a tire wall structure, per se. For example, it is entirely possible in a practical sense to manufacture a dynamic-motion target structure, such as the sidewall of a tire, originally with embedded intumescence elements, with these elements either (a) being distributed relatively uniformly throughout the entire body of tire material, such as the sidewall material which is to be protected, or (b) being prepared in such a fashion that the intumescence elements are located principally in an outer thickness region of structure such as a tire sidewall.

As will be explained below, the structure and methodology of the invention utilize several defensive mechanisms in rapid response to a fire threat to suppress or quell that threat in an extremely effective manner. These various mechanisms, as well as other features and advantages which are offered by the present invention, will become more fully apparent as the description which now follows is read in conjunction with the accompanying drawings.

### DESCRIPTION OF THE DRAWINGS

FIG. 1 is a fragmentary, schematic section through a mounted vehicle tire, the sidewalls in which, on opposite sides of the tire, are being prepared for anti-fire behavior by being sprayed with a fire-protective coating made in accordance with one preferred implementation of, and one preferred manner of practicing, the present invention.

FIGS. 2 and 3 are enlarged and fragmentary schematic illustrations of one portion of a sidewall in the tire of FIG. 1, illustrating, with FIGS. 2 and 3 viewed collectively, responsive action of the fire-protective coating and of a population therein of embedded intumescence elements.

FIG. 4 is a simplified, schematic side illustration of a military personnel-carrying vehicle, the undersurface of which has been protected by a fire-protective coating prepared in accordance with the same implementation of the invention associated with FIGS. 1, 2 and 3 in the drawings.

FIG. 5 is a very simplified, cross-sectional illustration of the shell of a military helmet, the outer surface of which has been coated with a fire-protective coating prepared in accordance with the present invention.

FIGS. 6A, 6B, 6C are similar to FIGS. 2 and 3, except that they show, in somewhat greater detail, the rapid anti-fire-response which takes place in the behavior of the coatings illustrated in FIGS. 1-5, inclusive.

FIGS. 7A, 7B, 7C are somewhat similar to FIGS. 6A, 6B, 6C, respectively, except that they illustrate another implementation of the invention, shown particularly with respect to the sidewall of a vehicle tire, where, instead of a coating being applied to a tire sidewall, the elastomeric qualities per se of the sidewall function as a carrier for an embedded population of intumescence elements in accordance with practice of the present invention. In these three figures, it is assumed that intumescence elements are distributed relatively uniformly throughout the entire body of the illustrated tire sidewall structure.

FIG. 8 illustrates another approach for integrating a population of embedded intumescence elements into, for example, the sidewall structure of a tire, where these intumescences elements are distributed only in an outer-thickness portion of a region of that sidewall structure.

FIG. 9 is a very simplified, block/schematic flow diagram generally illustrating preparation of the structure pictured in FIGS. 7A, 7B, 7C.

FIG. 10 is very much like FIG. 9, except that it pictures one manner of preparing a structure such as that shown in FIG. 8.

### DETAILED DESCRIPTION OF THE INVENTION

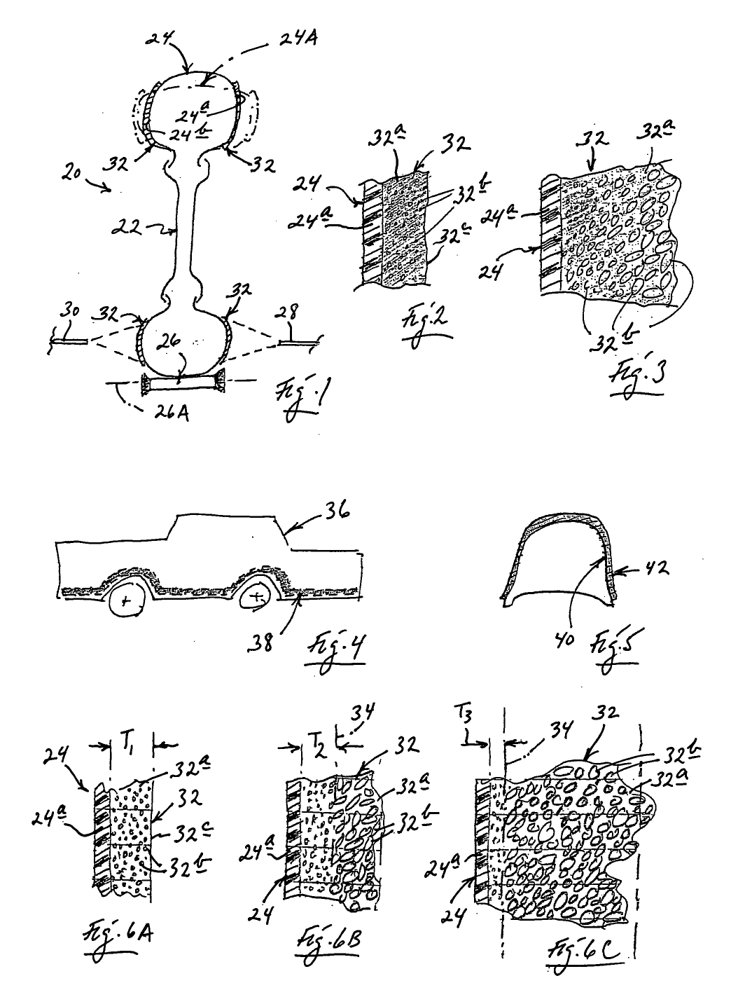

Beginning the description with respect to FIG. 1 in the drawings, indicated generally at 20 is a vehicle wheel which includes the usual central supporting wheel component 22 on the rim of which is mounted a conventional, elastomeric tire 24 (a target structure) which includes outer and inner sidewall structures generally shown at 24a, 24b, respectively. During the normal working life of wheel 20, tire 24 operates as a dynamic-motion flexing structure in the usual expected manner, and this is very generally indicated by dash-dot lines shown at 24A in FIG. 1.

In accordance with one preferred manner of implementing the present invention, with the outer perimeter of tire 24 in wheel 20 supported on an appropriate pair of spaced, rotational-motion-accommodating idlers, such as idler 26, which rotate on generally horizontal, fixed-position axes, such as axis 26A seen in FIG. 1, the wheel is rotated, and a spray coating of a protective composite material prepared in accordance with one embodiment of the invention is applied to the outer surfaces of sidewalls 24a, 24b via appropriate conventional spray instrumentalities 28, 30, respectively, which are shown in very simplified and fragmentary forms in FIG. 1. These applied coatings, each also referred to herein both as a fire-inhibiting protective coating, as a self-protecting fire inhibiting structure, and as a dynamic-motion structure, are shown at 32 in FIG. 1.

According to the invention, each coating 32, is formed preferably of a high-elastomeric material such as that sold under the trademark TUFF STUFF®FR, made by Rhino Linings USA, Inc. in San Diego, Calif., to have a thickness residing somewhere typically in the range of about 0.1-inches to about 0.5-inches. In the particular coating now being described, this coating has been prepared on the sidewalls in tire 24 to have a thickness of about ⅜-inches. In FIG. 2, this coating thickness is seen as the lateral dimension of coating 32. The elastomeric portion of coating 30 is also referred to herein as a body of material, and as a wall structure.

Speaking a bit more specifically about the structure of coating 32, the elastomeric body of this coating, shown at 32a, includes an embedded population of distributed intumescence elements which occupy the coating somewhere in the range of about 30% to about 50% by volume. These intumescence elements which, in the embodiment of the invention now being described, preferably take the form of sodium silicate crystals, have a mesh size of about 100-mesh, are relatively evenly distributed throughout material body 32a and are shown generally at 32b in FIG. 2. Other types of known intumescent materials may also be employed if desired. Embedding of elements 32b is accomplished upstream from where spray application of coating 32 takes place, whereby the contents of the sprays illustrated by dashed lines in FIG. 2 include an appropriate blend of both the employed high-elastomeric material and the intumescence elements.

Elements, or crystals, 32b, when taking the form of the mentioned sodium silicate crystals, respond to fire heat which reaches a temperature of about 500-degrees F., with a rapid, popping, volumetric expansion which causes coating 32 effectively to function as a heat-responsive “growth” structure. Coating 32 is thus referred to herein as having a heat-responsive growth nature. When the outer surface 32c in coating 32 is exposed to a threatening fire which reaches or exceeds this “expansion, or popping, temperature”, and as what can be thought of as a front of this popping temperature moves inwardly through layer 32 from its outside toward a tire sidewall, such as sidewall 24a, at least two important, mechanical mechanisms function to protect tire 24 against combustion.

The first of these mechanisms involves the outwardly thrusting popping and expanding characteristic of the embedded sodium crystals.

The second of these mechanisms involves the progressively inwardly advancing popping/expansion of intumescence elements, as can clearly be seen in the schematic illustration provided toward the right side of FIG. 3 in the drawings, with this expansion causing the overall lateral dimension, or thickness, of layer 32 to increase. In making a comparison of what is shown in FIG. 3 with respect to what is shown in FIG. 2, such a thickness growth, or expansion, can there be seen illustrated. As coating thickness growth takes place, this phenomenon retards progressively the time to dangerous temperature rise occurring at tire sidewall 24a. Experience has shown that overall thickness growth of a coating like coating 32 in response to the heat of fire is typically up to about 200%.

Referring for a moment to FIGS. 6A, 6B, 6C, these three figures show, in somewhat greater illustrative detail, the two fire-protective mechanisms just described. In FIG. 6A, the nominal (applied) thickness of coating 32 is shown at T₁. FIG. 6B illustrates, very generally, what happens when the outside surface of layer 32 is exposed to a threatening fire, with respect to which the overall thickness of layer 32 has begun to grow because of the temperature-responsive popping and enlarging actions of the embedded sodium silicate crystals. Associated with this activity is the phenomenon of a progressively inwardly moving popping-temperature front, represented by a dash-dot line 34 in FIG. 6B. In FIG. 6B, line 34 can now be seen to be somewhat closer to the outside surface of sidewall 24a than was the original outside surface 32c of coating 32. This newly-created dimension which is shown at T₂ in FIG. 6 is somewhat smaller than dimension T₁ shown in FIG. 6A.

FIG. 6C illustrates a somewhat later point in time, wherein (1) the popping temperature front represented by line 34 has advanced to an even smaller distance, or dimension T₃, with respect to the outer surface of sidewall 24a, and (2), the thickness of layer 32 has grown more as a consequence of progressive inwardly advancing popping and expansion of crystals 32b.

It is thus this mechanical growth-nature reaction of coating 32 which helps to protect a target structure, such as tire sidewall 24a, from combustion. Where coating expansion due to the embedded crystals' popping actions has “finished”, the nature of coating 32 in that region is that of a charred, foam-like crystalline structure.

Turning attention for a moment to FIGS. 4 and 5, illustrated generally at 36 in FIG. 4 is a military personnel-carrying vehicle, the undersurface (outer surface) of which has been coated for fire protection by a coating 38 which is much like previously described spray-applied coating 32. Similarly, in FIG. 5 there is shown, very generally at 40, the shell of a military helmet, the outside surface of which has been fire-protected by a spray-applied coating 42 which is also much like previously described coating 32. The undersurface of vehicle 36, and helmet shell 40, are also referred to herein as dynamic-motion structures because of the fact that, during their operating lifetimes, and in the course of normal use, they undergo structural motion deformation. In all three of the target, protected structures shown in FIGS. 1-6C, inclusive, the fact that coating body 32a (and its counterparts in FIGS. 4 and 5) is/are formed of a high-elastomeric material, helps to assure that, during normal pre-fire-attack time, coatings, such as coating 32, 38, 42 effectively remain properly attached and configured for responsive reaction when a fire threat actually occurs.

It should be understood that while one preferred elastomeric body material has been identified herein, other “elastomeric” materials which are fire resistant, and which may be characterized with a relatively wide range of elasticities, including some material which may feel relatively stiff, may be employed in certain applications.

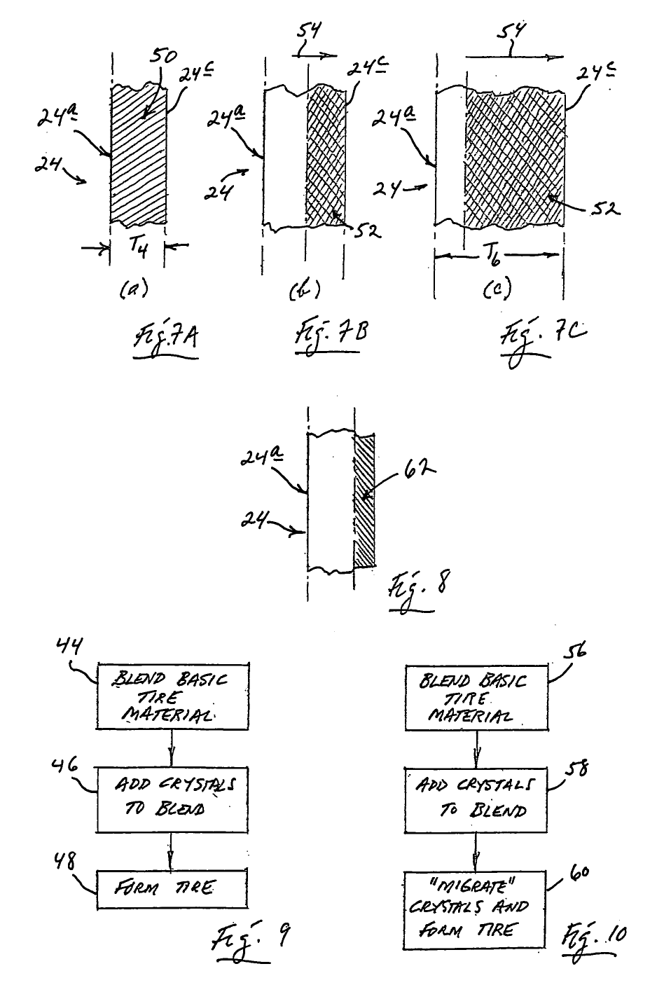

Focusing attention now on the remaining drawings figures, i.e., FIGS. 7A-10, inclusive, here what generally is illustrated are two slightly different versions of a second embodiment of, and manner of practicing, the present invention. In this embodiment of the invention, rather than there being an applied protective coating for an independent, or other, target structure, the elements of the invention are effectively formed integrally to become a part of a protected target structure. For illustration purposes herein, this other embodiment of the present invention is illustrated and described with respect to another manner of protecting a tire sidewall structure, such as tire sidewall structure 24a.

Looking at FIGS. 7A, 7B, 7C, and 9, in this version of this second embodiment of the present invention, the basic material which is employed to create tire sidewall structure is appropriately blended (see blocks 44, 46 in FIG. 9) with intumescence elements, such as sodium silicate crystals, to form tire 24 (see block 48 in FIG. 9). More specifically, the blending and adding of intumescence elements is done in such a fashion that there is a relatively uniformly distributed population of embedded elements in the particularly chosen, typical elastomeric material used to form tire 24. This “throughout”, relatively uniform distribution of embedded elements is illustrated by the shading presented at 50 in FIG. 7A. A representative initial thickness for sidewall structure 24a is shown at T₄ in FIG. 7A.

FIGS. 7B and 7C illustrate two successively later time intervals after sidewall 24a, and particularly the outer surface 24c of this sidewall, has been exposed to fire. In FIG. 7B, as the tire sidewall heats up in response to a threatening fire, an advancing temperature popping front 52 has advanced a certain distance into the tire sidewall as a consequence of an outer portion of the population of embedded intumescence elements having reactived with popping expansion in relation to the threatening fire. This expanded-size population of elements is shown generally with cross-hatched shading at 52 in FIG. 7B. The overall thickness of sidewall 24a has obviously increased, and this increased size is shown at T₅ in FIG. 7B.

FIG. 7C shows a later point in time in which the popping temperature front has advanced more within the thickness of sidewall 24a, as a consequence of a greater number of the embedded intumescence elements having gone through a popping expansion behavior. Overall tire sidewall thickness has increased further, and this larger dimension is shown at T₆ in FIG. 7C. In FIGS. 7B, 7C, the advancing, or increasing, thickness growth of sidewall 24a is shown generally by arrow 54.

Turning attention now to FIGS. 8 and 10, in this version of the second described embodiment and manner of practicing the present invention, tire 24 and its sidewall structure, such as sidewall structure 24a, are initially prepared somewhat differently, as is illustrated generally in block/schematic form in FIG. 10. Basic tire material is appropriately blended with intumescence elements (see blocks 56, 58 in FIG. 10), and in any suitable fashion, introduced intumescence elements are effectively caused to “migrate” so that they become located only in an outer thickness portion, or region, of the overall thickness of a tire sidewall. The term “migrate” is intended to mean any approach or mechanism by which such a tire sidewall structure may be created. Migration approaches may be entirely conventional in character, and may include preparation of a structure, such as sidewall structure 24a, in a suitably layered manner.

FIG. 8 generally illustrates this somewhat different sidewall structure by shading shown generally at 62 in FIG. 8. Shading 62 represents an outer thickness portion of tire sidewall 24a wherein there is an embedded population of intumescence elements.

In all of the invention embodiments described herein, it is appreciated that an embedded population of intumescence elements may, instead of being uniformly distributed in embedding material, be distributed in a graduated fashion with respect to the volume occupancy by these elements—i.e., graduated as one progresses inwardly from the outer surface of either an applied protective coating or of an integrated structure containing embedded intumescence elements.

From a methodology point of view, the present invention can be thought of as a fire-inhibition method for protecting a target structure having a dynamic-motion surface, with this method including the steps of (a) applying an elastomeric, fire-resistant coating having a heat-responsive growth nature to such a surface, with the applied coating having an outer side, and (b), on the occurrence of the outer side of that coating becoming exposed to the heat of fire, invoking the heat-responsive growth nature of the coating progressively to grow the coating's thickness as temperature rise within the coating progresses inwardly from the coating's outer side.

Another way of visualizing the methodology of the invention is to see it as being a fire-inhibition method for protecting a target structure which has a dynamic-motion body, with this method including the steps of (a) embedding intumescence elements in the mentioned body, and (b), on the occurrence of the target structure body becoming exposed to the heat of fire, causing the body to increase in size via the reaction to such heat of the embedded intumescence elements.

The invention thus proposes novel structure and methodology for what is referred to herein as dynamic surface-structure fire suppression utilizing a special structure, applied either as an independent coating, or included as an integral part of a protected structure, wherein a body of elastomeric material embeds a population of distributed intumescence elements, such as sodium silicate crystals, which elements create, for the composite assembly of the elastomeric body and the crystals, a growth structure wherein growth occurs upon exposure to a threatening fire. While preferred embodiment and manner of practicing the invention have been described and illustrated herein specifically, we recognize that other variations and modifications are possible, and may be implemented by those skilled in the art, with these other approaches coming fully within the spirit of the present invention.

We claim:

1. A self-protecting, fire-inhibiting structure comprising
wall structure formed of an elastomeric material having an outwardly exposed surface which is at risk for exposure to the heat of fire, and
within said wall structure, a distributed population of intumescence elements.

2. The fire-inhibiting structure of claim 1, wherein said elements take the form of crystals of sodium silicate.

3. The fire-inhibiting structure of claim 1 which is at least part of a dynamic-motion target structure.

4. The fire-inhibiting structure of claim 3, wherein said target structure takes the form of a vehicle tire sidewall.

5. The fire-inhibiting structure of claim 1, wherein said wall structure forms at least a portion of a fire-inhibiting coating applied to an outer surface of another structure, which other structure is a target structure.

6. The fire-inhibiting structure of claim 5 which is a dynamic-motion structure, and said target structure is also a dynamic-motion structure.

7. The fire-inhibiting structure of claim 6, wherein said target structure takes the form of a vehicle tire sidewall.

8. A fire-inhibiting protective coating for target structure having a dynamic-motion surface comprising
a body of fire-resistant, elastomeric material, and
entrained in said material, a population of intumescence elements.

9. The coating of claim 8, wherein said elements take the form of sodium silicate crystals.

10. The coating of claim 8, wherein said material takes the form of a fire-resistant, polyurethane elastomer, and said elements take the form of sodium silicate crystals.

11. The coating of claim 8, wherein the target structure takes the form of one of (a) the sidewall of a vehicle tire, (b) the undersurface of a vehicle, and (c) the outer surface of a helmet shell.

12. A fire-inhibition method for protecting a target structure having a dynamic-motion surface comprising
applying an elastomeric, fire-resistant coating having a heat-responsive growth nature to such a surface with the applied coating having an outer side, and
on the occurrence of the outer side of that coating becoming exposed to the heat of fire, invoking the heat-responsive growth nature of the coating progressively to grow the coating's thickness as temperature rise within the coating progresses inwardly from the coating's outer side.

13. The method of claim 12, wherein said applying includes creating a distributed population of intumescence elements within the mentioned coating, and said invoking includes swelling these elements within the coating.

14. A fire-inhibition method for protecting a target structure which has a dynamic-motion body comprising
embedding intumescence elements in the body, and
on the occurrence of the target-structure body becoming exposed to the heat of fire, causing the body to increase in size via the reaction to such heat of the embedded intumescence elements.
